(19) United States
(12) Patent Application Publication
(10) Pub. No.: US 2026/0220662 A1
(43) Pub. Date: Jul. 30, 2026

(54) GENERATING OPTIMIZED AD GROUP PLAN FOR A CAMPAIGN

(71) Applicant: Walmart Apollo, LLC, Bentonville, AR (US)

(72) Inventors: Girish Sathyanarayana, Mysore (IN); Manasij Sur Roy, Bengaluru (IN); Dinesh Kumar Kadambala, Bengaluru (IN); Arpan Maheshwari, Bengaluru (IN); Jnanasree Konda, Bengaluru (IN); Sutirtha Chakraborty, Bengaluru (IN); Kunal Kishore, Bangalore (IN); Kuang-chih Lee, Fremont, CA (US); Pratyush Pushkar, Bangalore (IN)

(73) Assignee: Walmart Apollo, LLC, Bentonville, AR (US)

(21) Appl. No.: 19/041,859

(22) Filed: Jan. 30, 2025

(51) Int. Cl. G06Q 30/0242

(52) U.S. Cl. CPC G06Q 30/0244

(57) ABSTRACT

Examples relate to a computer-implemented method of system including a processor that can perform certain operations. The operations can include obtaining campaign inputs for a campaign associated with product specifications for an advertiser. The operations also can include generating, using an approximate nearest neighbor similarity search, targeting cuts for a targeting tactic based at least on the campaign inputs. The targeting cuts can be personalized to the advertiser and the product specifications. The operations additionally can include generating an optimized ad group plan including one or more groups of the targeting cuts and, for each of the one or more groups of the targeting cuts, a respective recommended maximum bid, a respective expected amount of winning impressions, and a respective budget allocation. The operations further can include outputting the optimized ad group plan for the campaign. Other embodiments are described.

### TECHNICAL FIELD

This disclosure relates generally to automated campaign generation for display advertising.

### BACKGROUND

Digital marketing strategies often use display advertising. Display advertising can involve the strategic placement of advertisements in various digital platforms to promote products or brands. Setting up a display advertising campaign generally involves specifying many parameters, such as ad groups, budget allocation, and bid strategies.

### BRIEF DESCRIPTION OF THE DRAWINGS

To facilitate further description of the embodiments, the following drawings are provided in which:

FIG. 1 illustrates a block diagram of a system that can be employed for automated campaign generation for display advertising, according to an embodiment;

FIG. 2 illustrates a flowchart for method for generating optimized ad campaigns, according to an embodiment;

FIG. 3 illustrates a flowchart for a method of using a targeting agent to generate targeting cuts, according to an embodiment;

FIG. 4 illustrates a flowchart for a method for generating keyword recommendations when the targeting tactic is keyword targeting, according to an embodiment;

FIG. 5 illustrates a flowchart of a method for generating taxonomy recommendations when the targeting tactic is contextual targeting, according to an embodiment;

FIG. 6 illustrates a flowchart for a method for generating audience recommendations when the targeting tactic is behavioral targeting, according to an embodiment;

FIG. 7 illustrates a plot of the non-linear win-rate function, along with three linear segments that form a piecewise function that is fit to approximate the non-linear win-rate function;

FIG. 8 illustrates a display screen of a campaign user interface, showing an example of inputting parameters for a campaign;

FIG. 9 illustrates a display screen of the campaign user interface, showing an example of an optimized ad group plan generated based on as selection of campaign inputs for keyword targeting;

FIG. 10 illustrates a display screen of the campaign user interface, showing an example of an optimized ad group plan generated based on a selection of campaign inputs for contextual targeting;

FIG. 11 illustrates a display screen of a campaign user interface, showing an example of an optimized ad group plan generated based on a selection of campaign inputs for behavioral targeting;

FIG. 12 illustrates a flowchart for a method of performing automated campaign generation, according to another embodiment;

FIG. 13 illustrates a front elevational view of a computer system that is suitable for implementing an embodiment of the system disclosed in FIG. 1; and

FIG. 14 illustrates a representative block diagram of an example of the elements included in the circuit boards inside a chassis of the computer system of FIG. 13.

### DETAILED DESCRIPTION

Display advertising is a common part of digital marketing strategies for advertisers seeking to promote their products online. As e-commerce platforms and digital marketplaces continue to grow, advertisers face increasing challenges in effectively reaching their target audiences and maximizing the impact of their advertising campaigns. Approaches to creating display advertising campaigns typically involve advertisers manually configuring many parameters, such as determining targeting cuts (e.g., keywords, taxonomies, or audiences that are targeted by the campaign), partitioning these targeting cuts among ad groups, splitting the campaign budgets appropriately among ad groups, assigning bids to each ad group, and attaching the relevant creative content (e.g., ad copies) to each ad group. Advertisers manually configure these options based on their experience in the advertising platform, which often leads to suboptimal campaign creation with low realization of the advertisers' goals (e.g., awareness, engagement, conversion). This process can be time-consuming, complex, and prone to suboptimal outcomes, especially for advertisers who may lack extensive experience or resources to fine-tune their campaigns. Additionally, the dynamic nature of online marketplaces means that consumer trends and product relevance can shift rapidly, such that an advertiser's experience can often be outdated.

Many embodiments can provide techniques to simplify, automate, and/or optimize the campaign creation process. For example, these techniques can take minimal inputs from the advertiser and create a campaign with an optimal set of ad groups with optimal configurations, which can lead to efficient realization of the campaign's goal of spreading awareness, such as via maximizing the number of impressions served to customers. Such techniques can be capable of processing large volumes of data, identifying relevant targeting opportunities, and optimizing campaign structures in real-time. Such techniques can balance automation with advertiser control and transparency. Although fully automated solutions can save time and resources, many advertisers still want visibility into the decision-making process and the ability to fine-tune recommendations based on their specific knowledge and preferences, which can be provided by these techniques.

Various embodiments include a system including a processor and a non-transitory computer-readable medium storing computing instructions that, when executed on the processor, cause the processor to perform certain operations. The operations can include obtaining campaign inputs for a campaign associated with product specifications for an advertiser. The operations also can include generating, using an approximate nearest neighbor similarity search, targeting cuts for a targeting tactic based at least on the campaign inputs. The targeting cuts can be personalized to the advertiser and the product specifications. The operations additionally can include generating an optimized ad group plan including one or more groups of the targeting cuts and, for each of the one or more groups of the targeting cuts, a respective recommended maximum bid, a respective expected amount of winning impressions, and a respective budget allocation. The operations further can include outputting the optimized ad group plan for the campaign.

A number of embodiments include a computer-implemented method. The method can include obtaining campaign inputs for a campaign associated with product specifications for an advertiser. The method also can include generating, using an approximate nearest neighbor similarity search, targeting cuts for a targeting tactic based at least on the campaign inputs. The targeting cuts can be personalized to the advertiser and the product specifications. The method additionally can include generating, using a mixed integer non-linear programming formulation, an optimized ad group plan including one or more groups of the targeting cuts and, for each of the one or more groups of the targeting cuts, a respective recommended maximum bid, a respective expected amount of winning impressions, and a respective budget allocation. The method further can include outputting the optimized ad group plan for the campaign.

Additional embodiments include a non-transitory computer-readable medium storing computing instructions that, when executed on a processor, cause the processor to perform certain operations. The operations can include obtaining campaign inputs for a campaign associated with product specifications for an advertiser. The campaign inputs can include a duration and a budget. The operations also can include generating, using an approximate nearest neighbor similarity search, targeting cuts for a targeting tactic based at least on the campaign inputs. The targeting cuts can be personalized to the advertiser and the product specifications. The operations additionally can include generating an optimized ad group plan including one or more groups of the targeting cuts and, for each of the one or more groups of the targeting cuts, a respective recommended maximum bid, a respective expected amount of winning impressions, and a respective budget allocation. The operations further can include outputting the optimized ad group plan for the campaign.

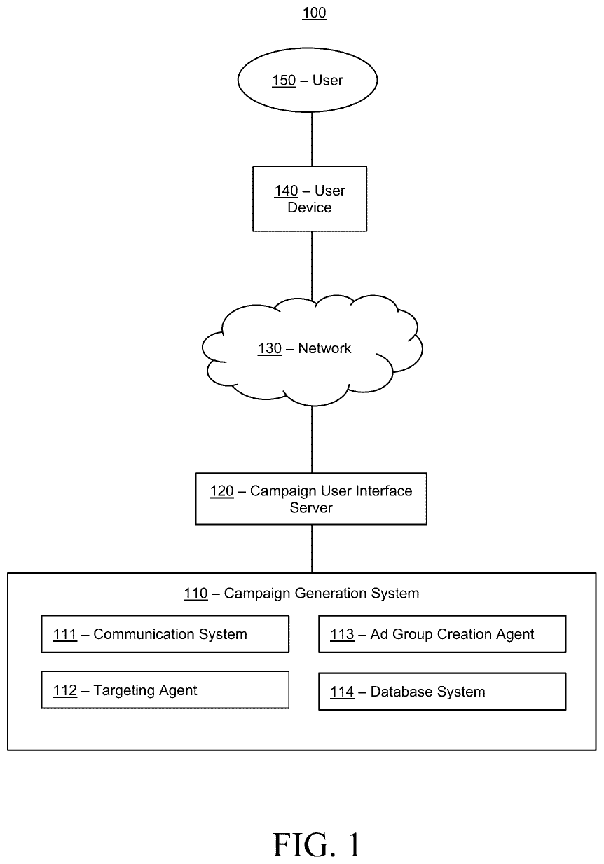

Turning ahead in the drawings, FIG. 1 illustrates a block diagram of a system 100 that can be employed for automated campaign generation for display advertising, according to an embodiment. System 100 is merely an example, and embodiments of the system are not limited to the embodiments presented herein. The system can be employed in many different embodiments or examples not specifically depicted or described herein. In some embodiments, certain elements, modules, or systems of system 100 can perform various procedures, processes, and/or activities. In other embodiments, the procedures, processes, and/or activities can be performed by other suitable elements, modules, or systems of system 100. In some embodiments, system 100 can include a campaign generation system 110 and/or a campaign user interface server 120. Generally, system 100 can be implemented with hardware and/or software, as described herein.

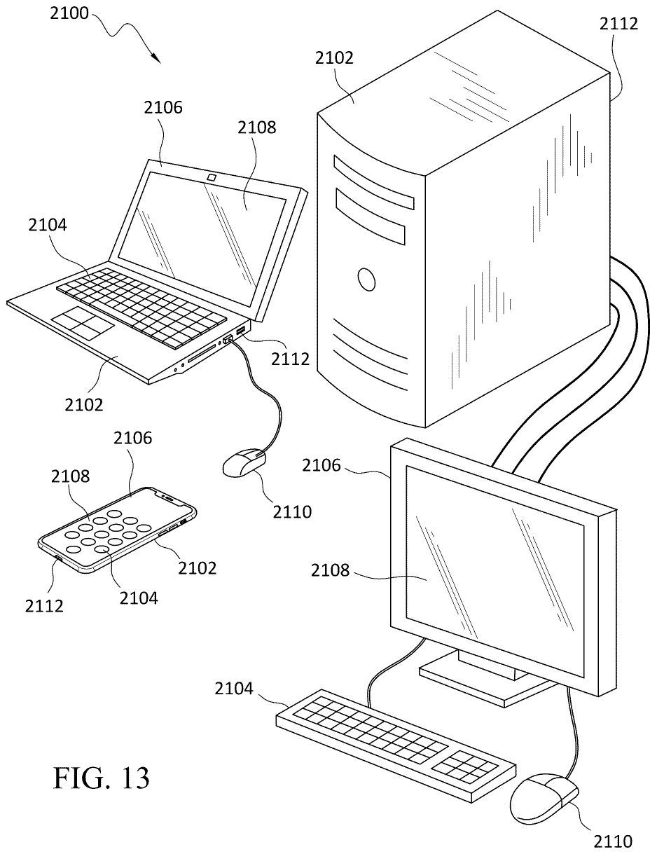

Campaign generation system 110 and/or campaign user interface server 120 can each be a computer system, such as computer system 2100 (FIG. 13), as described below, and can each be a single computer, a single server, or a cluster or collection of computers or servers, or a cloud of computers or servers. In another embodiment, a single computer system can host campaign generation system 110 and/or campaign user interface server 120.

In some embodiments, campaign user interface server 120 can be in data communication through a network 130 with one or more user devices, such as a user device 140. User device 140 can be part of system 100 or external to system 100. Network 130 can be the Internet or another suitable network. In some embodiments, user device 140 can be used by advertisers, such as a user 150. In many embodiments, campaign user interface server 120 can host one or more websites and/or mobile application servers. For example, campaign user interface server 120 can be a web server that hosts a website, or provides a server that interfaces with an application (e.g., a mobile application), for user device 140, which can allow users (e.g., 150) to create and/or manage an advertising campaign.

In some embodiments, an internal network that is not open to the public can be used for communications between campaign generation system 110 and campaign user interface server 120 within system 100. Accordingly, in some embodiments, campaign generation system 110 (and/or the software used by such systems) can refer to a back end of system 100 operated by an operator and/or administrator of system 100, and campaign user interface server 120 (and/or the software used by such systems) can refer to a front end of system 100, as is can be accessed and/or used by one or more users, such as user 150, using user device 140. In these or other embodiments, the operator and/or administrator of system 100 can manage system 100, the processor(s) of system 100, and/or the memory storage unit(s) of system 100 using the input device(s) and/or display device(s) of system 100.

In certain embodiments, the user devices (e.g., user device 140) can be desktop computers, laptop computers, mobile devices, and/or other endpoint devices used by one or more users (e.g., user 150). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand.

Examples of mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement the iPhone® operating system by Apple Inc. of Cupertino, California, United States of America, the Android™ operating system developed by the Open Handset Alliance, or another suitable operating system.

In many embodiments, campaign generation system 110 and/or campaign user interface server 120 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). The input device(s) and the display device(s) can be coupled to campaign generation system 110 and/or campaign user interface server 120 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of campaign generation system 110 and/or campaign user interface server 120. In a similar manner, the processors and/or the non-transitory computer-readable media can be local and/or remote to each other.

Meanwhile, in many embodiments, campaign generation system 110 and/or campaign user interface server 120 also can be configured to communicate with one or more databases, such as a database system 114. The one or more databases can include an item database that contains information about display advertising campaigns, including historical campaign performance metrics, user behavior data, product catalogs, and market trend information. Additionally, database system 114 may contain advertiser profiles, targeting criteria, bid strategies, budget allocations, and real-time auction data to support the automated campaign creation and optimization processes. The one or more databases can be stored on one or more memory storage units (e.g., non-transitory computer readable media), which can be similar or identical to the one or more memory storage units (e.g., non-transitory computer readable media) described with respect to computer system 2100 (FIG. 13). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Examples of database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, campaign generation system 110, campaign user interface server 120, and/or the one or more databases can be implemented using any suitable manner of wired and/or wireless communication. Accordingly, system 100 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Examples of PAN protocol(s) can include Bluetooth, Zigbee, Wireless Universal Serial Bus (USB), Z-Wave, etc.; examples of LAN and/or WAN protocol(s) can include Institute of Electrical and Electronic Engineers (IEEE) 802.3 (also known as Ethernet), IEEE 802.11 (also known as WiFi), etc.; and examples of wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, examples of communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further examples of communication hardware can include wireless communication hardware including, for example, one or more radio transceivers, one or more infrared transceivers, etc. Additional examples of communication hardware can include one or more networking components (e.g., modulator-demodulator components, gateway components, etc.).

In many embodiments, campaign generation system 110 can include a communication system 111, a targeting agent 112, an ad group creation agent 113, and/or database system 114. In many embodiments, the systems and agents of campaign generation system 110 can be modules of computing instructions (e.g., software modules) stored at non-transitory computer readable media that operate on one or more processors. In other embodiments, the systems of campaign generation system 110 and/or campaign user interface server 120 can be implemented in hardware.

In many embodiments, communication system 111 can facilitate data exchange between various components of the campaign generation system 110 and other systems, such as the campaign user interface server 120. Communication system 111 can handle the transmission of campaign inputs, targeting data, and optimization results between the targeting agent 112, ad group creation agent 113, and database system 114. Additionally, communication system 111 can manage real-time data flows in the campaign creation and optimization processes.

In many embodiments, targeting agent 112 can analyze data to generate personalized targeting cuts for display advertising campaigns. Targeting agent 112 can utilize machine learning algorithms, such as deep learning methods, including approximate nearest neighbor searches and embedding techniques, to process historical campaign data, consumer behavior patterns, and real-time market trends, and generate the targeting cuts that are relevant to the products and/or brands of the campaign. These targeting cuts (also referred to as targeting supply cuts) can include the search keywords, taxonomies, and/or audiences to target in the campaign. The targeting cuts can be determined even before the campaign is launched. Targeting agent 112 can output the targeting cuts (e.g., relevant keywords, taxonomies, and/or audience segments tailored to the advertiser's specific products, brand, and/or campaign goals.

In many embodiments, ad group creation agent 113 can generate ad group plans using optimization techniques, such as mixed integer non-linear programming model. Ad group creation agent 113 can process inputs from the targeting agent 112, along with inventory forecasts (e.g., ad-request supply and/or bid-landscape forecasts), to determine optimal groupings of the targeting cuts determined by targeting agent 112, as well as the recommended maximum bids, expected winning impressions, and budget allocations for these ad groups. Ad group creation agent 113 can balance multiple objectives to create efficient and effective campaign structures that maximize advertiser return on investment while adapting to dynamic market conditions. The non-linear win-rate functions can be approximate using piecewise linear functions to make the mixed integer nonlinear programming optimization computationally feasible. These ad groups can each be a set of targeting cuts through which the advertising platform displays ads to targeted customers. The bid landscape can represent the cumulative distribution of winning rates as per bid prices submitted by advertisers in auctions. The win rate can be the chance of winning impressions by targeting cut.

In many embodiments, these techniques can provide automated campaign creation, which can allow the advertisers discover new targeting cuts which were not known to them or expected by them earlier, so that the advertiser can discover new valuable customers. In many embodiments, these techniques can be highly adaptable so as to work on the latest inventory forecasts in order to adapt to changing consumer trends at finer levels. This adaptable approach can provide improved results in automation without performing time and/or expensive A/B tests to arrive at the optimal campaign configuration to the maximization of an advertiser's goals. In many embodiments, the techniques can provide capability to ingest the advertiser's own knowledge, so that advertisers can provide their own preferred targeting cuts, and the system can expand on those cuts and can also use those preferred targeting cuts in the final ad groups after the budget split across the ad groups.

In many embodiments, the techniques can provide technical improvements by using technical approaches and solving technical problems. For example, these techniques can address the technical problems of difficulties in effectively reaching target audiences and maximizing campaign impact, time-consuming and complex manual configuration of multiple parameters, suboptimal outcomes due to lack of experience or resources, rapidly shifting consumer trends and product relevance, increasing complexity of digital advertising ecosystems, and/or difficulty in leveraging vast amounts of data effectively. The techniques can provide technical improvements of more sophisticated and automated approaches to campaign creation, personalized and optimized campaign recommendations, real-time processing of large volumes of data, adaptive tools that provide up-to-date recommendations based on latest data and market conditions, intelligent systems that simplify campaign creation while maximizing return on investment, and/or balancing automation with advertiser control and transparency. The techniques can provide these technical improvements using technical implementations, such as advanced data processing techniques to handle large volumes of e-commerce platform data, machine learning algorithms for identifying relevant targeting opportunities, real-time optimization of campaign structures, automated systems for configuring targeting criteria, budget allocation, and bid strategies, data-driven tools for adapting to dynamic market conditions, and/or user interfaces that provide visibility into the decision-making fine-tuning of recommendations.

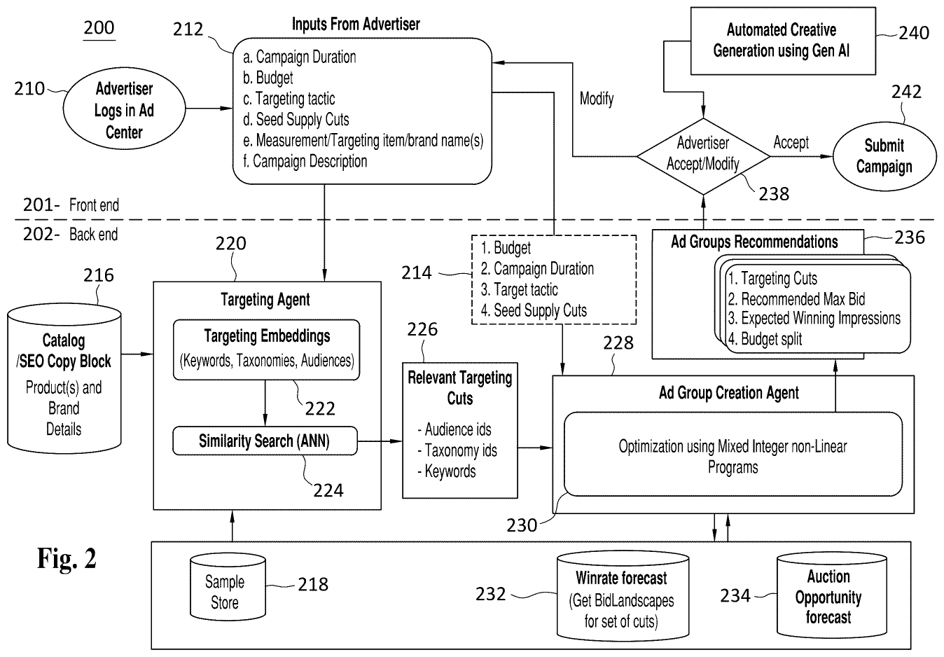

Turning ahead in the drawings, FIG. 2 illustrates a flowchart for method 200 for generating optimized ad campaigns, which includes a front-end system 201 and a back-end system 202. Method 200 is merely an example and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any suitable order. In still other embodiments, one or more of the procedures, the processes, and/or the activities of method 200 can be combined or skipped. Front-end system 201 can be similar or identical to campaign user interface server 120 (FIG. 1), and/or back-end system 202 can be similar or identical to campaign generation system 110 (FIG. 1).

As shown in FIG. 2, method 200 can include activity 210 of an advertiser (e.g., user 150 (FIG. 1)) logging into an ad center, such as a campaign user interface provided by front-end system 201. Next, method 200 can involve an activity 212 of obtaining campaign input parameters. For example, the advertiser can enter input parameters such as campaign duration, such as the start date and end date of the campaign; a total budget for the campaign; a targeting tactic for the campaign, such as keyword targeting (KT), contextual targeting (CT), or behavior targeting (BT), or asking for a recommended targeting tactic; seed supply cuts, such as preferred targeting cuts; measurement/targeting items/brand names, such as products and/or brands that the advertiser wants to advertise or measure via the campaign; a campaign description, such as campaign message, campaign direction, target audience; and/or other suitable inputs. In many embodiments, one or more of these inputs can be optional. For example, in some cases, the advertiser can input limited inputs, such as the campaign duration and the budget, without specifying other input parameters. In many embodiments, one or more these inputs can be provided to a targeting agent 220 (which can be similar or identical to targeting agent 112 (FIG. 1)) and/or an ad group creation agent 228 (which can be similar or identical to ad group creation agent 113 (FIG. 1). For example, inputs 214, such as budget, campaign duration, targeting tactic, and seed supply cuts can be provided to ad group creation agent 228.

As an example of inputs, the products/brand selection can be BRAND A (a brand or car waxes and polishes), the budget can be $5,000, and the duration can be 14 days (1st November 2024 to 14th November 2024). Optional inputs can include the targeting tactic of keyword targeting. Another optional input can include seed supply cuts of car wash, foam cleaning, automobiles, and car polish. Another optional input can include a campaign description of: “In-market for car waxes & polishes. [BRAND A] Garage purchasers. Life-stage auto enthusiasts. Car Care Competitor Brand Purchasers. Top 30 auto purchasers. This is the first campaign, so we are hoping for more awareness around the brand and the products.”

Back-end system 202 can include targeting agent 220 and/or ad group creation agent 228. In many embodiments, product data 216 and/or sample store data 218 also can be used by targeting agent 220. Product data 216 can include descriptions of the products and/or brands selected by the advertiser for the campaign, which can be retrieved from a product catalog, and brand information can be retrieved from SEO (Search Engine Optimization) copy block. This production information can provide the advertiser's product specification. Sample store data 218 can include information about the ad inventory of targeting cuts for the platform, which can be updated regularly, such as daily or at other suitable intervals.

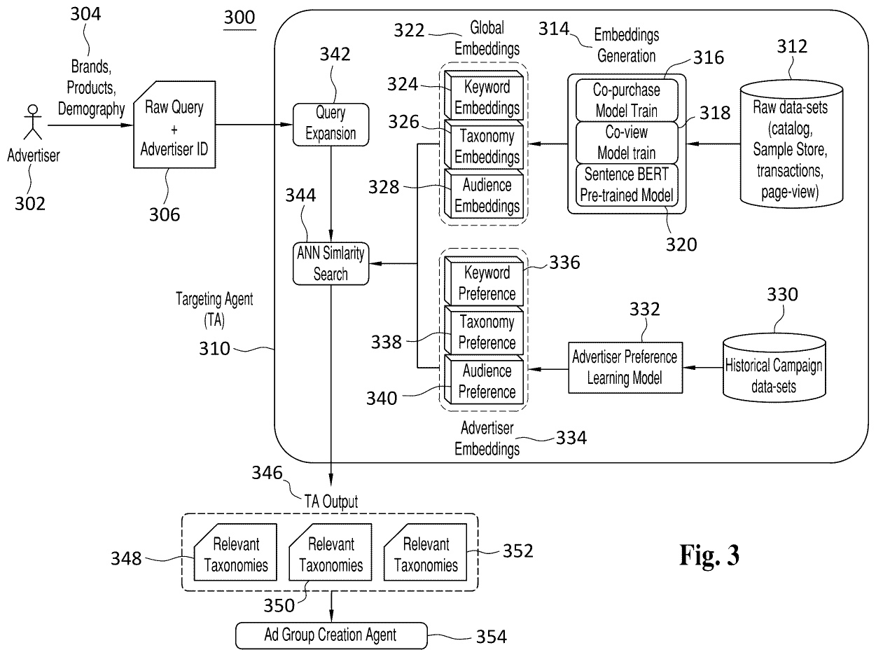

In many embodiments, targeting agent 220 can perform activity 222 of generating targeting embeddings for keywords, taxonomies, or audiences, followed by activity 224 of performing similarity searching (e.g., approximate nearest neighbor (ANN)) to generate relevant targeting cuts 226. Relevant targeting cuts 226 can include and/or identify the keywords, taxonomies, or audiences that are relevant to the campaign, based on the targeting tactic. In some embodiments, relevant targeting cuts 226 can be ranked in order of relevance. For example, for the targeting tactic of keyword targeting, the targeting cuts can be keywords. For the targeting tactic of contextual targeting, the targeting cuts can be taxonomies, or taxonomy identifiers. For the targeting tactic of behavioral targeting, the targeting cuts can be audiences, or audience identifiers. An example implementation of using the targeting agent to generate targeting cuts in shown in FIG. 3 and described below.

Turning ahead in the drawings, FIG. 3 illustrates a flowchart for a method 300 of using a targeting agent to generate targeting cuts. Method 300 is merely an example and is not limited to the embodiments presented herein. Method 300 can be employed in many different embodiments or examples not specifically depicted or described herein. In some embodiments, the procedures, the processes, and/or the activities of method 300 can be performed in the order presented. In other embodiments, the procedures, the processes, and/or the activities of method 300 can be performed in any suitable order. In still other embodiments, one or more of the procedures, the processes, and/or the activities of method 300 can be combined or skipped.

As shown in FIG. 3, method 300 can include an advertiser 302 (e.g., user 150 (FIG. 1)) providing inputs 304, such as the products, brands, and/or demographic information. These inputs can be processed as a raw query 306, which can be associated with an advertiser identifier (ID) for advertiser 302. For example, raw query 306 can represent the product and/or brand selected by advertiser 302, such as information obtained in product data 216 (FIG. 2). Raw query 306 and/or the advertiser ID can be provided to a targeting agent 310, which can be similar or identical to targeting agent 112 (FIG. 1) and/or targeting agent 220 (FIG. 2).

In many embodiments, targeting agent 310 also can input raw data 312, which can include catalog data, sample store data (e.g., 218 (FIG. 2)), transaction data, page-view data, and/or other suitable data regarding customer (e.g., shopper) behaviors, such as shoppers' purchase and/or browse behaviors. In many embodiments, raw data 312 can be used in an activity 314 of generating global embeddings 322 using one or more models, such as a co-purchase model 316, a co-view model 318, and/or a sentence transformer model 320. These models generate global embeddings 322, which can include keyword embeddings 324, taxonomy embeddings 326, or audience embeddings 328, depending on the targeting tactic. Global embeddings 322 can represent behaviors of customer (shoppers).

Co-purchase model 316 can be trained to capture item-item similarity based on purchase patterns, such that these embeddings provide complementary product recommendations. Co-view model 318 can be trained to capture item-item similarity based on browse patterns, such that these embeddings provide substitute product recommendations. Sentence transformer model 320 can be pretrained embeddings that are generated based on names of the keywords, taxonomies, or products associated with the audiences, such that these embeddings provide generic product recommendations.

In many embodiments, targeting agent 310 also can input historical campaign data 330, which can be processed in an activity 332 of generating advertiser embeddings 334. These advertiser embeddings 334 can include keyword preferences 336, taxonomy preferences 338, or audience preferences 340, depending on the targeting tactic. Advertiser embeddings 334 can represent preferences of advertiser 302, unless advertiser 302 is new, in which case, historical campaign data 330 for other advertisers similar to advertiser 302 can be used.

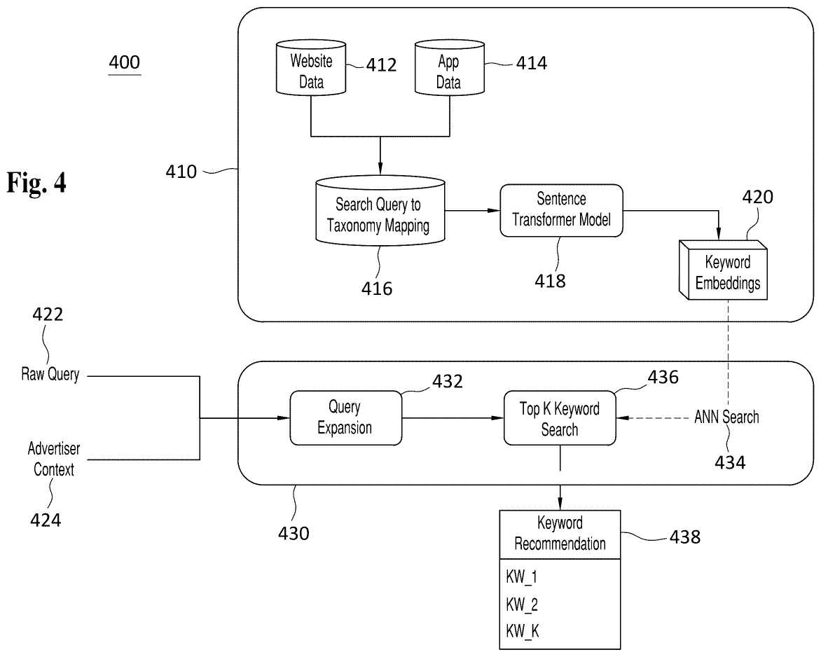

Targeting agent 310 can perform an activity 342 of query expansion, which can involve expending raw query 306 to cover additional aspects of the query and/or to extract intents from the raw query, such as brand, product, demography, etc. Targeting agent 310 also can perform an activity 344 of ANN similarity search using the expanded query, global embeddings 322 and advertiser embeddings 334, to generate targeting agent (TA) outputs 346. TA outputs 346 can include relevant targeting cuts, such as relevant keywords 348, relevant taxonomies 350, or relevant audiences 352, depending on the targeting tactic. In many embodiments, TA outputs 346 also can include relevance scores for the relevant targeting cuts. In many embodiments, TA outputs 346 can be similar or identical to relevant targeting cuts 226 (FIG. 2). TA outputs 346 can be input into an ad group creation agent 354, which can be similar or identical to ad group creation agent 113 (FIG. 1) and/or ad group creation agent 228 (FIG. 2). Ad group creation agent 354 can receives TA outputs 346 to create optimized ad groups in an optimized ad group plan, such as described below in connection with ad group creation agent 228 (FIG. 2). Example implementations for using the targeting agent for each of the different targeting tactics are shown in FIGS. 4-6 and described below.

Turning ahead in the drawings, FIG. 4 illustrates a flowchart for a method 400 for generating keyword recommendations when the targeting tactic is keyword targeting. Method 400 is merely an example and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

As shown in FIG. 4, method 400 can include an offline embedding generation process 410 and an online keyword recommendation process 430. Offline embedding generation process 410 can use website data 412 and/or app data 414 to determine keywords that have been used in search queries and the product taxonomies of products for which customers (shoppers) engaged those keywords. This data can be used to generate keyword sentences, in which each keyword sentence is a concatenation of the keyword and the corresponding product taxonomy, forming search query to taxonomy mappings 416. Search query to taxonomy mapping 416 can be used in a sentence transformer model 418 to generate keyword embeddings 420. Sentence transformer model 418 can be BERT (Bidirectional Encoder Representations from Transformers) or another suitable model to generate keyword embeddings 420 that capture textual similarity of the keywords searched by customers (shoppers) using a website or application for shopping for products. In many embodiments, keyword embeddings 420 can be stored in a vector database. Keyword embeddings 420 can capture semantic similarity of keywords searched.

Online keyword recommendation process 430 can involve receiving inputs from a raw query 422 and advertiser context 424, which can be similar or identical to inputs 304 and/or raw query 306 (FIG. 3). These inputs can be processed in an activity 432 of query expansion, which can be similar or identical to activity 342 (FIG. 3). The expanded query then can be used in an activity 434 of performing an ANN search using keyword embeddings 420 to the most relevant keywords. ANN is an approximation of the nearest neighbor search in the embedding space, comparing a limited subset of embeddings (instead of an exhaustive search) in a way that approximates the exact solution, so as to be performed in real-time. Activity 436 can limit the results to the top K keywords, in which K can be a predetermined or configurable parameter, such as 10, 20, 50, etc. Online keyword recommendation process 430 can culminate in outputting a list of recommended keywords 438.

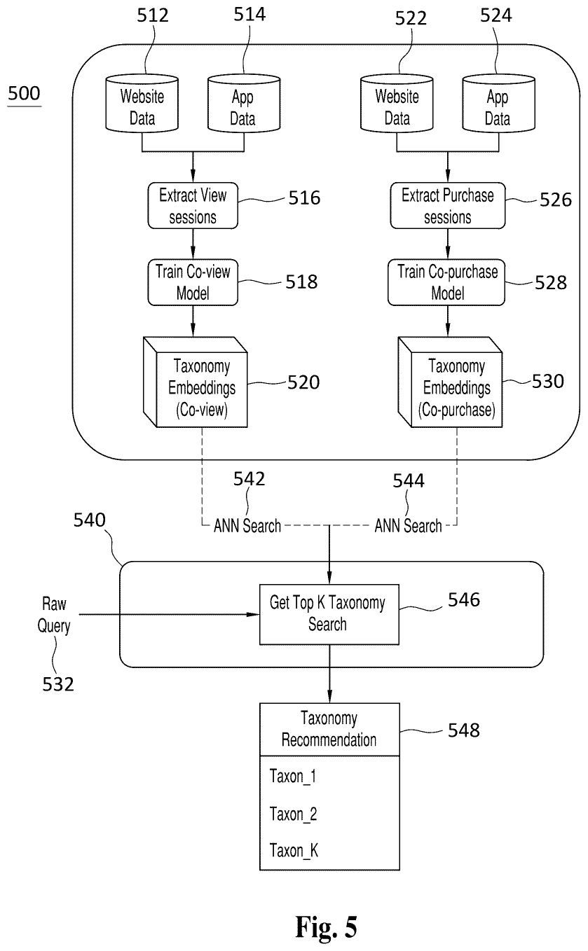

Turning ahead in the drawings, FIG. 5 illustrates a flowchart of a method 500 for generating taxonomy recommendations when the targeting tactic is contextual targeting. Method 500 is merely an example and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

As shown in FIG. 5, method 500 can include an offline embedding generation processes 510 and an online similarity search process 540. Offline embedding generation process 510 can involve two parallel paths. In a first parallel path, website data 512 and app data 514 can be used in an activity 516 of extracting view sessions. Each customer (shopper) browse session can be treated as a single sentence and each taxonomy viewed within the session can be a token within that sentence. A co-view model 518 can be trained on these sentences to generate co-view taxonomy embeddings 520. Co-view model 518 can be a skip-gram based word2vec model or another suitable model. Co-view taxonomy embeddings 520 can be a dense representation of the taxonomies capturing substitute aspects of the taxonomies. Taxonomy embeddings can capture semantic similarity of products browsed and/or sold.

In a second parallel path of offline embedding generation process 510, website data 522 and app data 524 can be used in an activity 526 of extracting purchase sessions. Each customer (shopper) purchase session can be treated as a single sentence and each taxonomy for products purchased within the session can be a token within that sentence. A co-purchase model 528 can be trained on these sentences to generate co-purchase taxonomy embeddings 530. Co-purchase model 528 can be a skip-gram based word2vec model or another suitable model. Co-purchase taxonomy embeddings 530 can be a dense representation of the taxonomies capturing complementary aspects of the taxonomies. Co-view taxonomy embeddings 520 and co-purchase taxonomy embeddings 530 can be stored in respective vector databases.

Online similarity search process 540 can involve receiving a raw query 532, which can be similar or identical to raw query 306 (FIG. 3). Raw query 532 can be processed through an activity 542 for co-view embeddings and an activity 544 for co-purchase embeddings, as two parallel ANN search operations. An activity 546 can determine the top K results from each operation, and these results can be combined to get the final top K taxonomy results by a voting mechanism. Method 500 can output taxonomy recommendations 548, which can include the top K taxonomy recommendations.

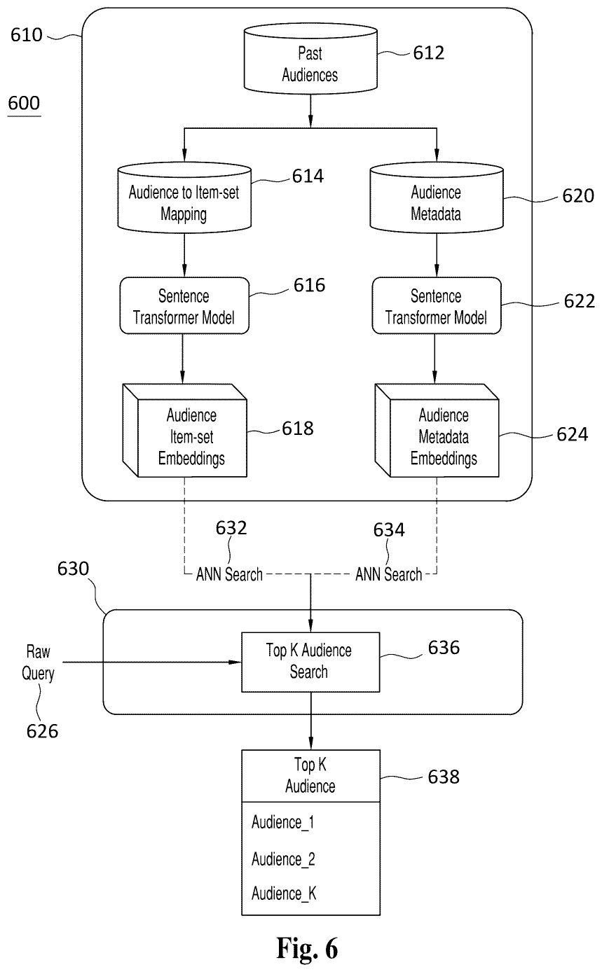

Turning ahead in the drawings, FIG. 6 illustrates a flowchart for a method 600 for generating audience recommendations when the targeting tactic is behavioral targeting. Method 600 is merely an example and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

As shown in FIG. 6, method 600 can include an offline embedding generation process 610 and an online similarity search process 630. Offline embedding generation process 610 can use past audiences data 612 through two parallel paths, such that each audience is represented by two sub-parts: (i) item-set, as the set of items that the customers (shoppers) are predicted to purchase in the future, and (ii) audience metadata, a various metadata associated with the audience, such as name, description, type, etc. In the first path, past audiences data 612 is used to create audience to item-set mappings 614, and then for each item in the item-set, concatenating multiple attributes of the item (e.g., name, brand, taxonomy, material, color, etc.) to create a sentence. The sentences are input into a sentence transformer model 616 to generate item embeddings, and average embeddings of the item embeddings within the item-set can be used to generate audience item-set embeddings 618.

In the second path, past audiences data 612 is used to extract audience metadata 620 by concatenating multiple attributes of the audience (e.g., name, description, demographic information, interests, behaviors) to create a sentence. The sentences are input into a sentence transformer model 622 to generate audience metadata embeddings 624. These embeddings capture the semantic meaning of the audience characteristics and allow for similarity comparisons based on audience descriptions and attributes. Sentence transformer models 616 and 622 can be similar or identical to sentence transformer model 418 (FIG. 4). Audience item-set embeddings 618 and audience metadata embeddings 624 can be stored in respective vector databases. These audience embeddings can represent each shopper segment created for display ads by advertisers.

Online similarity search process 630 can receive a raw query 626, which can be similar or identical to raw query 306 (FIG. 3). Raw query 626 can be processed through an activity 632 and activity 634 using ANN search on the audience item-set embeddings 618 and audience metadata embeddings 624 respectively. An activity 636 can determine the top K results from each operation, and these results can be combined to get the final top K results by a voting mechanism. Method 600 can output audience recommendations 638, which can be the final top K results.

Returning to FIG. 2, ad group creation agent 228 can obtain relevant targeting cuts 226 and perform activity 230 of a mixed integer non-linear programing (MINLP) model to generate an optimized ad group plan 236. In many embodiments, the MINLP model can utilize win-rate forecast data 232 including bid landscapes, such as bid landscapes for relevant targeting cuts 226, and/or auction forecast data 234, to generate optimized ad group plan 236. Optimized ad group plan 236 can include one or more ad groups, which can include sets of targeting cuts. For each of the ad groups, optimized ad group plan 236 can include recommended maximum bids, an expected amount of winning impressions, and budget allocation for the ad group.

Given a set of relevant targeting cuts, activity 230 can create ad groups. The ad groups can serve as fundamental units for advertising operations to provide display ads to targeted customers (shoppers). Ad group creation agent 228 can build an optimized set of ad groups for the campaign and presents them to the advertisers. Activity 230 can formulate the challenging problem of selecting and grouping targeting cuts in the MINLP model. The solution of this MINLP model can output an optimal configuration, such as grouping the targeting cuts into ad groups, and maximum bid price and ad spends for each ad group to maximize the total impressions (awareness), as represented by Equation 6 described below, and subject to various constraints as listed in Equations 7-17 described below.

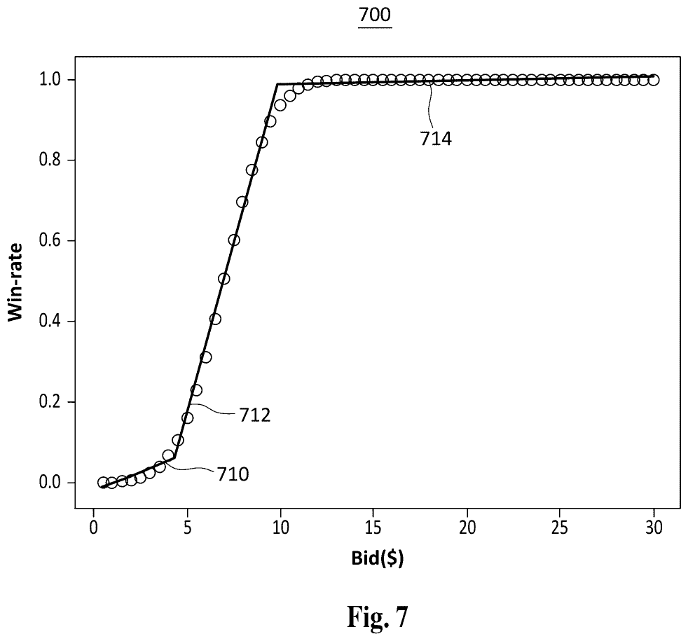

The MINLP model forecasts winning impressions at different bids to solve for the decision variables. In many embodiments, API (application programming interface) calls to external systems, such as an inventory management system, can be made to obtain data such as win-rate forecast data 232, and auction forecast data 234. In many embodiments, targeting agent 220 also can make similar API calls to obtain sample store data 218. Because the win-rate cumulative distribution functions for the targeting cuts are continuous non-linear functions, thus the search space for the MINLP solver is very big and thus renders the optimization computationally infeasible, due to too much time and/or processing resources to solve. Although, the win-rate functions are discretized over a set of bid value in a range, the cardinality is still huge. An improvement to overcome these processing challenges is using a piecewise approximation of the non-linear win-rate functions into a small number of linear segments, such as three linear segments. Using this innovation, the optimization task converges in real time. An example of such an approximation is illustrated in FIG. 7, which illustrates a plot of the non-linear win-rate function, along with three linear segments 710, 712, and 714 that form a piecewise function that is fit to approximate the non-linear win-rate function.

For the MINLP model, the following variables listed in Table 1 can be used:

TABLE 1

| Variables | Representation |
|---|---|
| N_{SC} | Number of seed targeting cuts provided by advertiser |
| Nₖ | Total number of targeting cuts in the campaign |
| | (including seed targeting cuts) |
| N_{A} | Maximum number of ad groups in a campaign |
| Sᵢ | Forecast of impressions for i^{th} targeting cut |
| WRᵢ | Forecast of win-rate function for i^{th} targeting cut |
| B | Total advertising budget for the campaign |
| bₘᵢₙ | Floor price |
| bₘₐₓ | Maximum bid price |
| N_{cmin} | Minimum number of targeting cuts in each ad group |
| | (to avoid lean ad groups) |
| αₘᵢₙ | Minimum budget fraction per ad group |
| Rᵢⱼ | Binary decision variable indicating whether i^{th} |
| | targeting cut is assigned to j^{th} ad group or not |
| δⱼ | Binary decision variable indicating whether j^{th} ad |
| | group of out of maximum allowed N_{A} ad groups is |
| | created or not |
| bⱼ | Decision variable for optimal bid price for j^{th} ad group |
| αⱼ | Decision variable for allocated budget fraction for j^{th} |
| | ad group |
| Eᵢ | Effective supply available for i^{th} targeting cut. |
| AOᵢ | Historical auction opportunities (AO) (historical Sᵢ) |
| | for i^{th} targeting cut. |
| r(i_0, i_1, . . . | Non-Overlap Ratio of AO (auction opportunity) for z |
| i_j, . . . i_z) | selected targeting cuts out of Nₖ |
| Zᵢ | The number of ad group assignments for i^{th} targeting |
| | cut |

Auction Opportunity (AOᵢ) represents the number of ad requests available for the auction in the past D days, where D is the duration considered to build the sample store.

For Effective Supply (Eᵢ), because some customers are common in audience segments (behavioral targeting), their respective supplies are not additive in order to arrive at the total supply for an ad group for such audiences. So, decision variable Eᵢ represents the effective supply which should be less than Sᵢ. In the case of keyword and contextual targeting Eᵢ is equal to Sᵢ due to non-overlapped supply between any two keywords and taxonomies.

For Non-overlap Ratio r(i_0,i_1, . . . i_j, . . . i_z), the following formula in Equation 1 can be used to measure the non-overlap ratio of auction opportunities among different audience segments or product taxonomies. Equation 1 can calculates the ratio (r) for a combination of targeting cut sets, where the numerator is the size (cardinality) of the union of these sets, and the denominator is the sum of the sizes (cardinalities) of each individual targeting set. Note that these are the sets of impressions. In case of keyword and contextual targeting the non-overlap, the ratio will become 1 due to non-overlapped supply among targeting cuts.

$$r ( i\_ 0 , i\_ 1 , … i\_i , … i\_z ) = \frac{\vert {AO}_{i \_ 0} ⋃ {AO}_{i \_ i} ⋃ … ⋃ {AO}_{i \_ z} \vert}{\vert {AO}_{i \_ 0} \vert + \vert {AO}_{i \_ i} \vert + … \vert {AO}_{i \_ z} \vert} \qquad Eq ( 1 )$$

where i_<j and i,j ∈ belongs to {0,1, 2, . . . . Nₖ−1}, z represents index of selected targeting cuts out of Nₖ−1. There can be chosen z cuts out of N_k cuts in

$$( \begin{matrix}N\_k \\ z\end{matrix} )$$

ways, where z can vary from 2 to N_k. So, there would be

$$( \begin{matrix}N\_k \\ 5\end{matrix} )$$

values of r if calculating these r-values for the various groups of 5 targeting cuts. In total the number of r-values would be:

$$( \begin{matrix}N\_k \\ 2\end{matrix} ) + ( \begin{matrix}N\_k \\ 3\end{matrix} ) + ( \begin{matrix}N\_k \\ 4\end{matrix} ) + … + ( \begin{matrix}N\_k \\ N\_k\end{matrix} ) .$$

For the MINLP model, the objective function can be derived as follows. Let Sᵢ denote the total forecasted impressions (auction opportunities in the non-guaranteed display advertising platform) available for the i^{th} targeting cut in the future duration provided by an advertiser. Given an advertising campaign with total advertising budget of B and a set of relevant targeting cuts (Nₖ) emitted out by the targeting agent, N_{A} represents the maximum number of ad groups as in Equation 2 below and decision variable δⱼ, j=0,1,2, . . . . N_{A-1} represents whether j^{th} ad group is created as shown in Equation 3 below, and Rᵢⱼ represents whether i^{th} targeting cut is assigned to the j^{th} ad group as shown in Equation 4 below, and αⱼ represents the fraction of budget B allocated to the ad group j as ad spend.

$${N}_{A} = min ( \frac{1}{{α}_{min}} , \frac{{N}_{k}}{{N}_{cmin}} ) \qquad Eq ( 2 )$$

$${δ}_{j} = \{ \begin{matrix}1 & if {j}^{th} adgroup is selected \\ 0 & otherwise\end{matrix} \qquad Eq ( 3 )$$

$${R}_{ij} = \{ \begin{matrix}1 & if {i}^{th} targeting cut assigned to {j}^{th} adgroup \\ 0 & otherwise\end{matrix} \qquad Eq ( 4 )$$

$${Z}_{i} = {{\sum }_{j = 0}}^{{N}_{A - 1}} {R}_{ij} ∀ i ∈ \{ 0 , 1 , 2 , … {N}_{k} - 1 \} \qquad Eq ( 5 )$$

In an auction triggered for Rᵢⱼ, targeting cut i of ad group j, let the ad group bids at bⱼ, then expected number of winning impressions for that targeting cut would be δⱼ*Rᵢⱼ*Eᵢ*WR (bⱼ) and ad spend would be δⱼ*Rᵢⱼ*Eᵢ*WR (bⱼ)*bⱼ. Therefore, for an awareness goal campaign, the objective function for the MINLP model would be to maximize the sum of these expected winning impressions across all targeting cuts in all ad groups as shown in Equation 6 below:

$$Objective : Maximize {{\sum }_{j = 0}}^{{N}_{A} - 1} {{\sum }_{i = 0}}^{{N}_{k} - 1} {δ}_{j} ( {R}_{ij} * {E}_{i} * W {R}_{i} ( {b}_{j} ) ) \qquad Eq ( 6 )$$

In this objective function of Equation 6, the objective is to maximize the total impressions across all the ad groups. The win-rate function (WR) is a piecewise approximation to make the MINLP model computationally feasible.

The MINLP model can include a number of constraints, as provided in Equations 7-17 below. In search advertising, the same targeting cut is typically not assigned to multiple ad groups, as ads from the same advertiser compete against each other and reduce the effectiveness of the campaign. Hence Equation 7 below supports assigning each targeting cut to at most one ad group:

$${{\sum }_{j = 0}}^{{N}_{A} - 1} {R}_{ij} \leq 1 ∀ i ∈ \{ {N}_{SC} , {N}_{SC} + 1 , {N}_{SC} + 2 , … {N}_{k} - 1 \} \qquad Eq ( 7 )$$

Seed targeting cuts can be an optional input from the advertiser, which include targeting cuts provided by the advertiser from previous campaigns performance and own experience of the advertiser. Equation 8 and Equation 9 below represent constraints to incorporate the seed targeting cuts while creating the ad groups. Equation 8 provides a constraint that each seed targeting cut is assigned to one ad group only and Equation 9 provides a constraint that seed targeting cut is mapped to only a created ad group out of N_{A}.

$${{\sum }_{j = 0}}^{{N}_{A} - 1} {R}_{ij} = 1 ∀ i ∈ \{ 0 , 1 , 2 , … {N}_{SC} - 1 \} \qquad Eq ( 8 )$$

$${R}_{ij} \leq {δ}_{j} ∀ j ∈ \{ 0 , 1 , 2 , … {N}_{SC} - 1 \} \qquad Eq ( 9 )$$

With fewer targeting cuts in each ad group, it can be operationally challenging to maintain high ad relevance, which is beneficial for achieving effective ad performance. Equation 10 below prevents creation of such lean ad groups by assigning at least N_{cmin} number of targeting cuts to each created ad group. For example, the minimum number of keywords in an ad group can be set to 5 or another suitable minimum number.

$${{\sum }_{i = 0}}^{{N}_{k} - 1} {R}_{ij} \geq {δ}_{j} * {N}_{cmin} ∀ j ∈ \{ 0 , 1 , 2 , … {N}_{A} - 1 \} \qquad Eq ( 10 )$$

Equation 11 below provides a constraint that the total advertising budget (B) is fully utilized across all ad groups provided there is enough supply of impressions. For a total advertising budget (B), it can be allocated among (N_{A}) ad groups, and each ad group's budget will be αⱼ*B. The constraint provides that adding up budgets of all ad groups will equal the total budget (B).

$${{\sum }_{j = 0}}^{{N}_{A} - 1} {α}_{j} = 1 \qquad Eq ( 11 )$$

Advertisers usually have a limited budget for display advertising. In some situations, the budget is less than what can be spent on the available supply of impressions. Let αⱼ*B>0 denote the advertising budget available to a given ad group j, so then ad spend are represented in Equation 12 below.

$${{\sum }_{i = 0}}^{{N}_{k} - 1} ( {R}_{ij} * {E}_{i} * W {R}_{i} ( {b}_{j} ) ) * {b}_{j} \leq {α}_{j} * B ∀ j ∈ \{ 0 , 1 , 2 , … {N}_{A} - 1 \} \qquad Eq ( 12 )$$

Equation 13 below provides a constraint to allocate a minimum ad spend of αₘᵢₙ* B for each adgroup as it avoids forming ad groups with fewer targeting cuts, which could be cumbersome to track performance and optimize efficiently. So, for balancing the number of supply cuts in ad groups, the following constraints can be used.

$${{\sum }_{i = 0}}^{{N}_{k} - 1} ( {R}_{ij} * {E}_{i} * W {R}_{i} ( {b}_{j} ) ) * {b}_{j} \geq {δ}_{j} * {a}_{min} * B \qquad Eq ( 13 )$$

$$∀ j ∈ \{ 0 , 1 , 2 , … {N}_{A} - 1 \}$$

Equation 14 provides a constraint that the effective supply is less than or equal to forecasted supply of each targeting cut due to overlapping audiences (BT). In the case of keyword or contextual targeting, effective supply is equal to forecasted supply.

$$0 \leq {E}_{i} \leq {S}_{i} ∀ i ∈ \{ 0 , 1 , … {N}_{k} - 1 \} \qquad Eq ( 14 )$$

Equations 15-17 below are used in the optimization model when targeting tactic selected is behavioral targeting, since the forecasted supply could have overlaps. The left-hand side of Equation 15 represents the combined effective non-overlapped forecasted supply for the i^{th} and j^{th} audience segments, but only if both segments are selected (since (Zᵢ) and (Zⱼ) are binary). The right-hand side of Equation 15 represents the combined forecasted impressions for the i^{th} and j^{th} audience segments, adjusted by the coefficient r(i, j). This constraint provides that the optimization respects the limits of the forecasted impressions, accounting for overlaps between audience segments. By doing so, it prevents overestimation of the available ad impressions when two audience segments are targeted simultaneously. Similarly, Equation 15-17 prevent overestimation of available impressions by encoding the similar constraints for all the groups of 2,3,4, . . . . Nₖ audience segments. In scenarios of no overlap supply, such as in keyword and contextual targeting, r (i,j) will be 1, and the below constraints simplify to (Eᵢ+Eⱼ) ZᵢZⱼ≤(Sᵢ+Sⱼ) ZᵢZⱼ which is inherently satisfied based on Equation 14.

$$( {E}_{i} + {E}_{j} ) {Z}_{i} {Z}_{j} \leq r ( i , j ) * ( {S}_{i} + {S}_{j} ) {Z}_{i} {Z}_{j} \qquad Eq ( 15 )$$

$$∀ i , j s . t . i < j ; i , j ∈ \{ 0 , 1 , … {N}_{k} - 1 \}$$

$$( {E}_{i} + {E}_{j} + {E}_{k} ) {Z}_{i} {Z}_{j} {Z}_{k} \leq r ( i , j , k ) * ( {S}_{i} + {S}_{j} + {S}_{k} ) {Z}_{i} {Z}_{j} {Z}_{k} \qquad E q ( 16 )$$

$$∀ i , j , k s . t . i < j < k ; i , j ∈ \{ 0 , 1 , … {N}_{k} - 1 \}$$

$$( {E}_{0} + {E}_{1} + … + {E}_{{N}_{k} - 1} ) {Z}_{0} {Z}_{1} … {Z}_{{N}_{k} - 1} \leq r ( 0 , 1 , … {N}_{k} - 1 ) * ( {S}_{0} + {S}_{1} + … + {S}_{{N}_{k} - 1} ) {Z}_{0} {Z}_{1} … {Z}_{{N}_{k} - 1} \qquad Eq ( 17 )$$

Continuing with FIG. 2, in many embodiments, method 200 can include outputting optimized ad group plan 236 to the advertiser, and asking the advertiser to accept or modify the ad group plan. If the advertiser chooses to modify the ad group plan, in some embodiments, the campaign user interface can provide the advertiser with the ability to modify the recommended ad groups by adding and/or removing targeting cuts from recommended ad groups, and/or method 200 can return to activity 212 of updating the inputs with these modified targeting cuts as seed supply cuts, to rerun the process of generating targeting cuts and optimizing the ad groups. If the advertiser accepts the ad group plan, the ad group plan to be output/submitted to the advertising platform for the advertising campaign in an activity 242. In some embodiments, method 200 can include an activity 240 of automating creative generation, such as using GenAI (generative artificial intelligence), based on the products and/or brands selected for the campaign, and these creatives can be submitted in activity 242.

In many embodiments, method 200 can address challenges in display advertising by providing an automated approach to campaign creation. Method 200 can use product data 216 and sample store data 218 to generate personalized and optimized campaign recommendations. The real-time processing capabilities of targeting agent 220 and ad group creation agent 228 can allow for quick adaptation to changing market conditions, addressing the dynamic nature of online marketplaces. Additionally, the ability for advertisers to review and modify recommendations in activity 238 can balance automation with advertiser control and transparency.

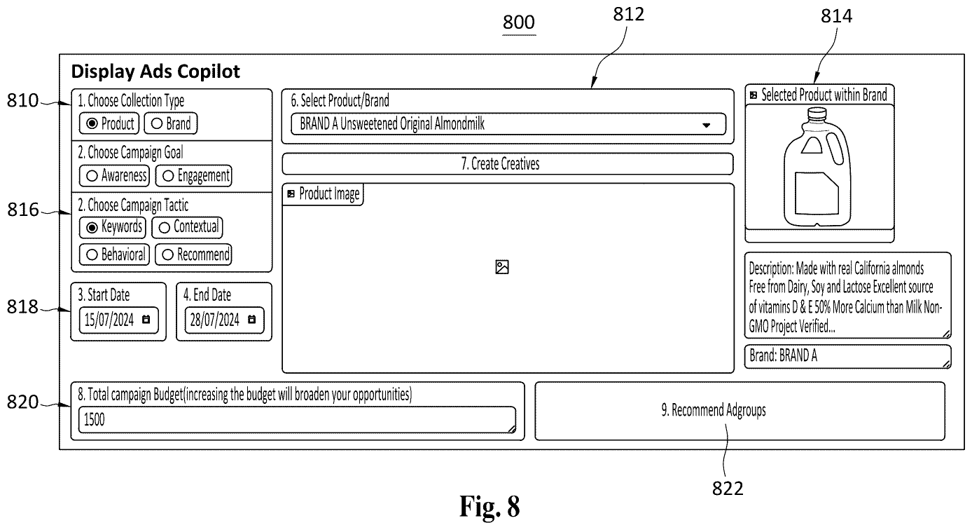

Jumping ahead in the drawings, FIG. 8 illustrates a display screen 800 of a campaign user interface, showing an example of inputting parameters for a campaign. Display screen 800 is merely an example and is not limited to the embodiments presented herein. As shown in FIG. 8, display screen 800 includes a collection type selector 810, which can allow the advertiser to select between product and brand options. Display screen 800 also includes a product/brand selector 812 to allow the advertiser to select a specific product or brand, such as using a dropdown menu for selecting specific products or brands, after which product details 814 can be displayed in a panel on the right side of display screen 800, showing product image and description information. Display screen 800 also includes a campaign tactic selector 816, which can allow the advertiser to select between different targeting tactics, such as keywords, contextual, or behavioral, or instead asking for a recommended targeting tactic. Display screen 800 also includes date input fields 818 for specifying campaign start and end dates, and a budget input field 820 for entering the total budget amount for the campaign. A recommendation button 822 can be used to generate an optimized ad group plan based on the selected inputs.

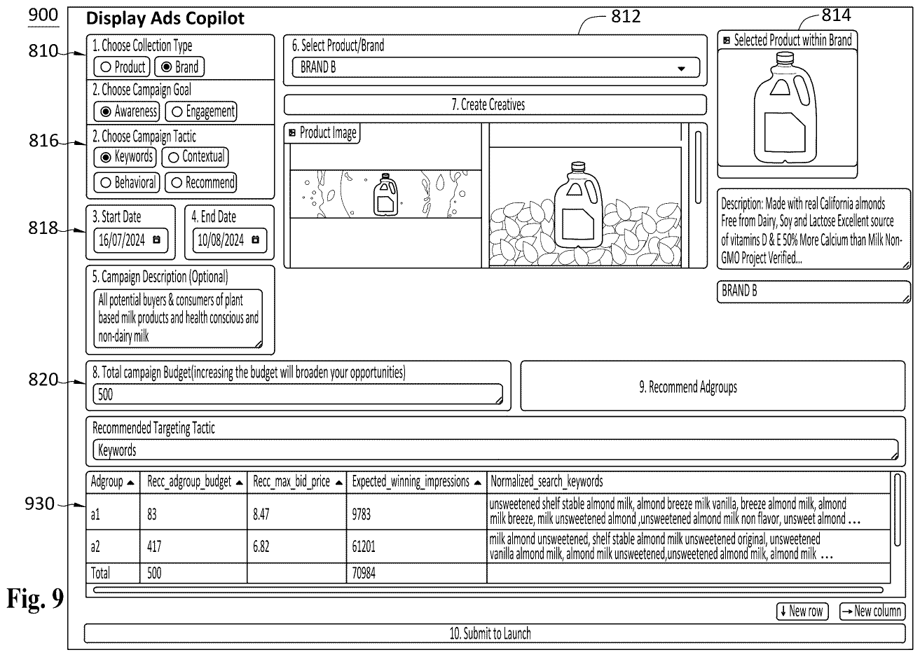

Turning ahead in the drawings, FIG. 9 illustrates a display screen 900 of the campaign user interface, showing an example of an optimized ad group plan generated based on as selection of campaign inputs for keyword targeting. Display screen 900 is merely an example and is not limited to the embodiments presented herein. As shown in FIG. 9, display screen 900 shows that advertiser selected brand in collection type selector 810, selected BRAND B in product/brand selector 812, selected keywords in campaign tactic selector 816, entered 16 Jul. 2024 to 10 Aug. 2024 in date input fields 818, and entered $500 in budget input field 820. Product details 814 are displayed in the upper right corner, showing an image and description of a BRAND B-brand product.

Display screen 900 additionally shows an ad group plan 930 that was generated based on these inputs. Ad group plan 930 presents detailed targeting and budget allocation information in a tabular format. Ad group plan 930 can display metrics such as budget allocations, bid prices, and expected winning impressions for different targeting segments. Ad group plan 930 can be the result of the optimization process performed by the ad group creation agent 228 (FIG. 2) based on the inputs provided by the advertiser. As shown in FIG. 9, ad group plan includes two ad groups, a1 and a2, each of which include the targeting cuts (keywords) listed in the normalized search keywords column. Ad group a1 is allocated $83, while ad group a2 is allocated $417. The recommended maximum bid price for ad group a1 is $8.47, for 9,783 expected winning impressions. The recommended maximum bid price for ad group a1 is $6.82, for 61,201 expected winning impressions.

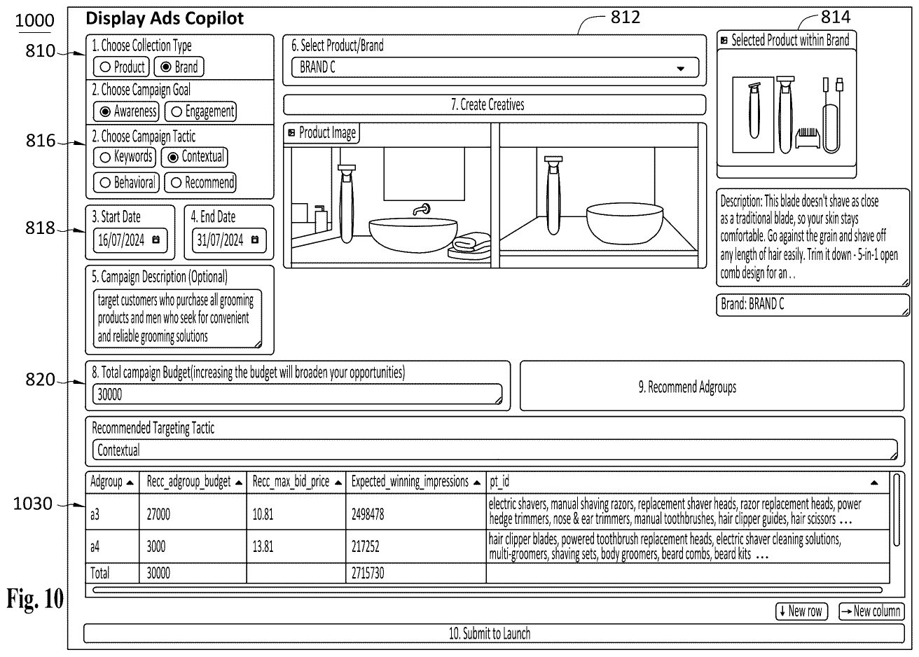

Turning ahead in the drawings, FIG. 10 illustrates a display screen 1000 of the campaign user interface, showing an example of an optimized ad group plan generated based on a selection of campaign inputs for contextual targeting. Display screen 1000 is merely an example and is not limited to the embodiments presented herein. As shown in FIG. 10, display screen 1000 shows that the advertiser selected product in collection type selector 810, selected BRAND C in product/brand selector 812, selected contextual in campaign tactic selector 816, entered 16 Jul. 2024 to 31 Jul. 2024 in date input fields 818, and entered $30,000 in budget input field 820. Product details 814 are displayed in the upper right corner, showing an image and description of the selected BRAND C product.

Display screen 1000 additionally shows an ad group plan 1030 that was generated based on these inputs. Ad group plan 1030 presents detailed targeting and budget allocation information in a tabular format. Ad group plan 1030 can display metrics such as budget allocations, bid prices, and expected winning impressions for different targeting segments. Ad group plan 1030 can be the result of the optimization process performed by the ad group creation agent 228 (FIG. 2) based on the inputs provided by the advertiser. As shown in FIG. 10, ad group plan 1030 includes two ad groups, a3 and a4, each of which includes the targeting cuts (taxonomies) listed in the product type identifier (pt_id) column. The table shows the budget allocation for each ad group, the recommended maximum bid price, and the expected winning impressions. For example, ad group a3 is allocated $27,000, with a recommended maximum bid price of $10.81, for 2,498,478 expected winning impressions. Ad group a4 is allocated $3,000, with a recommended maximum bid price of $13.81, for 217,252 expected winning impressions.

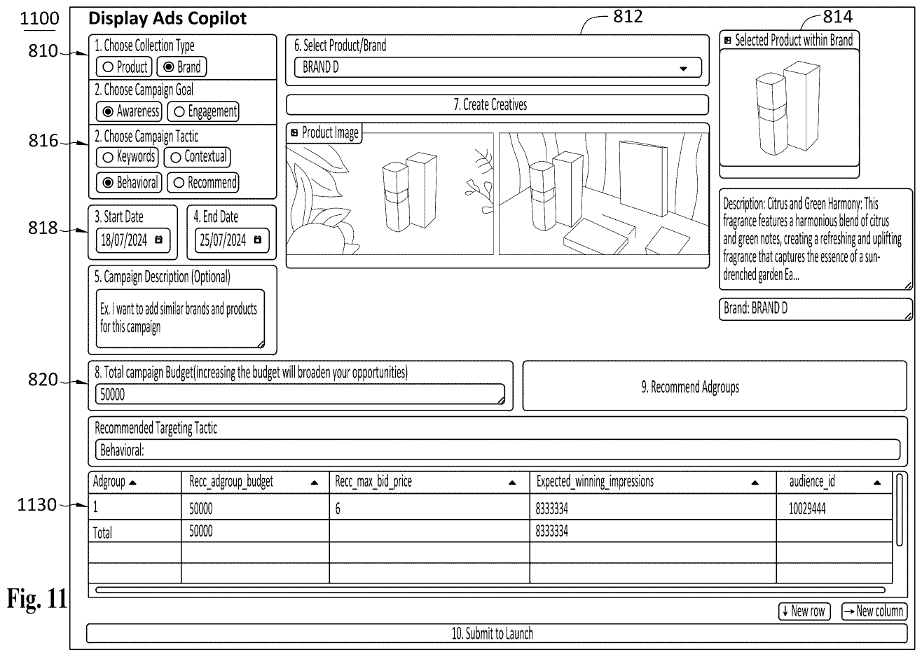

Turning ahead in the drawings, FIG. 11 illustrates a display screen 1100 of a campaign user interface, showing an example of an optimized ad group plan generated based on a selection of campaign inputs for behavioral targeting. Display screen 1100 is merely an example and is not limited to the embodiments presented herein. As shown in FIG. 11, display screen 1100 shows that the advertiser selected brand in collection type selector 810, selected BRAND D in product/brand selector 812, selected behavioral in campaign tactic selector 816, entered 18 Jul. 2024 to 25 Jul. 2024 in date input fields 818, and entered $50,000 in budget input field 820. Product details 814 are displayed in the upper right corner, showing an image and description of a BRAND D-brand product.

Display screen 1100 additionally shows an ad group plan 1130 that was generated based on these inputs. Ad group plan 1130 presents detailed targeting and budget allocation information in a tabular format. Ad group plan 1130 can display metrics such as budget allocations, bid prices, and expected winning impressions for different targeting segments. Ad group plan 1130 can be the result of the optimization process performed by the ad group creation agent 228 (FIG. 2) based on the inputs provided by the advertiser. As shown in FIG. 11, ad group plan 1130 includes a single ad group, which includes a targeting cut (an audience identifier) listed in the audience identifier column. The table shows the budget allocation for each ad group (here, one ad group), the recommended maximum bid price, and the expected winning impressions. For example, the ad group here is allocated $50,000, with a recommended maximum bid price of $6.00, for $8,333,334 expected winning impressions.

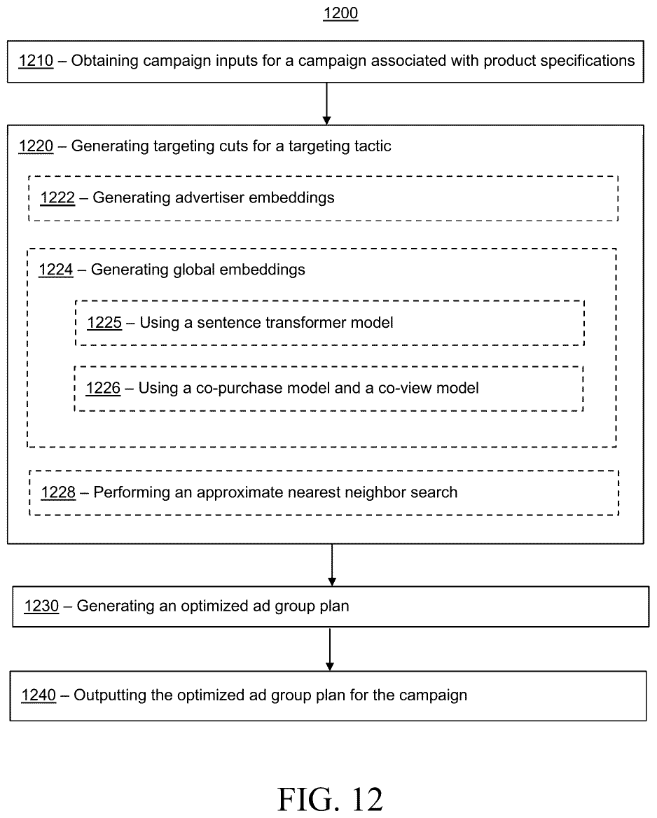

Turning ahead in the drawings, FIG. 12 illustrates a flowchart for a method 1200 of performing automated campaign generation, according to another embodiment. Method 1200 is merely an example, and the method is not limited to the embodiments presented herein. Method 1200 can be employed in many different embodiments or examples not specifically depicted or described herein. In some embodiments, the procedures, the processes, and/or the activities of method 1200 can be performed in the order presented. In other embodiments, the procedures, the processes, and/or the activities of method 1200 can be performed in any suitable order. In still other embodiments, one or more of the procedures, the processes, and/or the activities of method 1200 can be combined or skipped.

In many embodiments, system 100 (FIG. 1), campaign generation system 110 (FIG. 1), and/or campaign user interface server 120 (FIG. 1) can be suitable to perform method 1200 and/or one or more of the activities of method 1200. In these or other embodiments, one or more of the activities of method 1200 can be implemented as one or more computing instructions configured to run at one or more processors and configured to be stored at one or more non-transitory computer readable media. Such non-transitory computer readable media can be part of system 100 (FIG. 1). The processor(s) can be similar or identical to the processor(s) described below with respect to computer system 2100 (FIG. 1). In some embodiments, method 1200 and other activities in method 1200 can include using a distributed network including distributed memory architecture to perform the associated activity. This distributed architecture can reduce the impact on the network and system resources to reduce congestion in bottlenecks while still allowing data to be accessible from a central location.

Referring to FIG. 12, method 1200 can include an activity 1210 of obtaining campaign inputs for a campaign associated with product specifications for an advertiser. In many embodiments, the campaign inputs can be obtained from an advertiser through a campaign user interface, such as the used in connection with display screen 800 (FIG. 8). Campaign inputs can be similar or identical to the campaign inputs obtained in activity 212 (FIG. 2), inputs 214 (FIG. 2), inputs 304 (FIG. 3), raw query 306 (FIG. 3), raw query 422 (FIG. 4), advertiser context 424 (FIG. 4), raw query 532 (FIG. 5), and/or raw query 626 (FIG. 6). In many embodiments, activity 1210 can be performed by communication system 111 (FIG. 1) and/or campaign user interface server 120 (FIG. 1). In some embodiments, the campaign inputs can include a duration and a budget, and in some cases, can include a targeting tactic.

In many embodiments, method 1200 also can include an activity 1220 of generating, using an approximate nearest neighbor similarity search, targeting cuts for a targeting tactic based at least on the campaign inputs. In many embodiments, the targeting cuts can be personalized to the advertiser and the product specifications. In many embodiments, activity 1220 can be similar or identical to activities 222 and/or 224 performed by targeting agent 220 (FIG. 2), method 300 (FIG. 3), method 400 (FIG. 4), method 500 (FIG. 5), and/or method 600 (FIG. 6). In many embodiments, activity 1220 can be performed by targeting agent 112 (FIG. 1).

In some embodiments, activity 1220 can include an activity 1222 of generating advertiser embeddings for the targeting tactic based at least on historical campaign datasets. The advertiser embeddings can be similar or identical to advertiser embeddings 334 (FIG. 3), and the historical campaign datasets can be similar or identical to historical campaign data 330 (FIG. 3). Activity 1222 can be similar or identical to activity 332 (FIG. 3).

In some embodiments, activity 1220 also can include an activity 1224 of generating global embeddings for the targeting tactic based at least on historical shopping behaviors. The global embeddings can be similar or identical to global embeddings 322 (FIG. 3), and the historical shopping behaviors can be similar or identical to raw data 312 (FIG. 3). Activity 1224 can be similar or identical to activity 314 (FIG. 3).

In some embodiments, activity 1224 can include an activity 1225 of generating the global embeddings using a sentence transformer model. The sentence transformer model can be similar or identical to sentence transformer model 320 (FIG. 3), sentence transformer model 418 (FIG. 4), sentence transformer model 616 (FIG. 6), and/or sentence transformer model 622 (FIG. 6).

In some embodiments, activity 1224 can include an activity 1226 of generating the global embeddings using a using a co-purchase model and a co-view model. The co-purchase model can be similar or identical to co-purchase model 316 (FIG. 3) and/or co-purchase model 528 (FIG. 5). The co-view model can be similar or identical to co-view model 318 (FIG. 3) and/or co-view model 518 (FIG. 5).

In some embodiments, activity 1220 additionally can include an activity 1228 of performing the approximate nearest neighbor similarity search on advertiser embeddings and global embeddings. In many embodiments, activity 1228 can be similar or identical to activity 224 (FIG. 2), activity 434 (FIG. 4), activity 542 (FIG. 5), activity 544 (FIG. 5), activity 632 (FIG. 6), and/or activity 634 (FIG. 6).

In many embodiments, method 1200 additionally can include an activity 1230 of generating an optimized ad group plan comprising one or more groups of the targeting cuts and, for each of the one or more groups of the targeting cuts, a respective recommended maximum bid, a respective expected amount of winning impressions, and a respective budget allocation. In many embodiments, the optimized ad group plan can be similar or identical to optimized ad group plan 236 (FIG. 2), ad group plan 930 (FIG. 9), ad group plan 1030 (FIG. 10), and/or ad group plan 1130 (FIG. 11). Activity 1230 can be similar or identical to activity 230 performed by ad group creation agent 228 (FIG. 2). In many embodiments, activity 1230 can include using a mixed integer non-linear programming formulation to determine the one or more groups of the targeting cuts and optimize the respective budget allocation to each of the one or more groups. In many embodiments, the mixed integer non-linear programming formulation can use a piecewise function of linear segments to approximate a non-linear win-rate function. The linear segments of the piecewise function can be similar to linear segments 710, 712, and 714 (FIG. 7). In many embodiments, activity 1230 can be performed by ad group creation agent 113 (FIG. 1).

In many embodiments, method 1200 further can include an activity 1240 of outputting the optimized ad group plan for the campaign. In many embodiments, the optimized ad group plan can be transmitted for display to the advertiser on the campaign user interface, to allow the advertiser to modify or accept the optimized ad group plan. If accepted, the optimized ad group plan can be submitted as an campaign to the advertising platform. In many embodiments, activity 1240 can be performed by communication system 111 (FIG. 1) and/or campaign user interface server 120 (FIG. 1).

A comparative analysis was conducted between an implementation of the techniques described herein against a benchmark greedy approach. The greedy approach assumed average of cost per mille (CPM) (cost per thousand impressions) as the optimal bid price for each ad group and estimates the expected winning impressions (WI) at this average CPM bid price and selects the cheapest cuts first using relevance score from the targeting agent. The results demonstrate that the optimized approach described herein consistently outperforms the greedy approach in terms of WI with the same advertising budget constraints, with an average 20% lift in the expected advertiser reach.

The results demonstrate better realization of the campaign goal, meaning more impressions with the same budget, which provides improved outcomes for advertisers. The results also demonstrate better reach per dollar spent to the advertisers by exposing the previously unexplored targeting cuts and thereby increasing the fill-rates on such inventory-cuts. Due to better reach, advertisers could be inclined to increase their campaign spends. These techniques also can facilitate easy onboarding of the advertisers and thus in turn help the ad display platform grow quickly. Additionally, customers (shoppers) are served with more relevant ads right from the beginning of the campaign by reducing the exploration phase significantly and providing more opportunities to the advertisers to spend their advertising budgets.

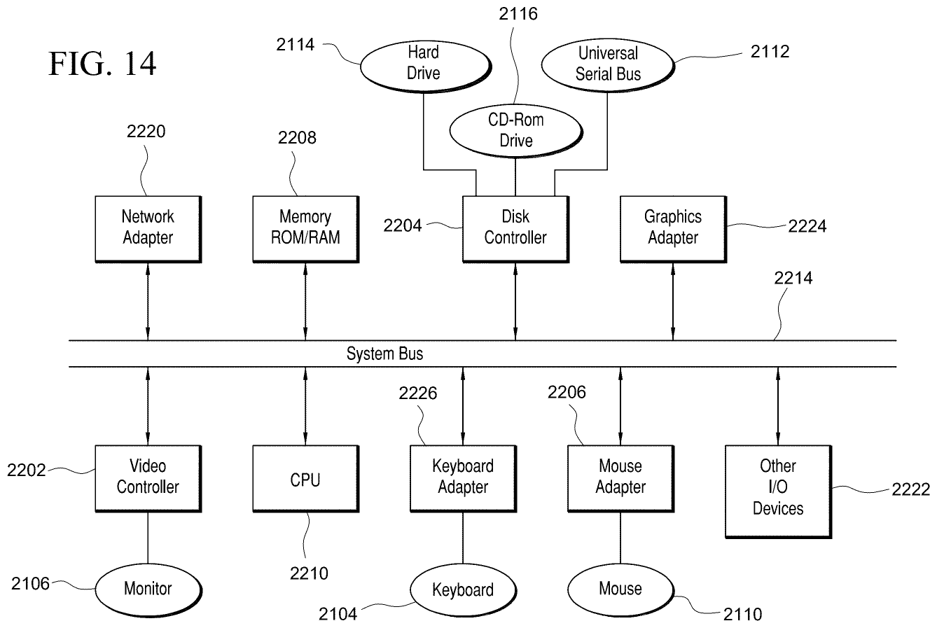

Turning to the drawings, FIG. 13 illustrates an embodiment of three different types (e.g., a tower server, a laptop, and a smart phone) of a computer system 2100. FIG. 14 illustrates a representative block diagram of elements included on the circuit boards inside a chassis 2102 of computer system 2100. All or a port of computer system 2100 can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 2100 (and its internal components, or one or more elements of computer system 2100) can be suitable for implementing part or all of the techniques described herein. Computer system 2100 can comprise chassis 2102 containing one or more circuit boards (not shown) and one or more of an input/output port 2112 (e.g., one or more Universal Serial Bus (USB) ports of one or more types (e.g., USB type-A, type-B, type-C, micro-A, micro-B, mini-A, mini-B, etc.), one or more High-Definition Multimedia interface (HDMI) ports, etc.).

A central processing unit (CPU) 2210 is coupled to a system bus 2214. In various embodiments, the architecture of CPU 2210 can be compliant with any of a variety of commercially distributed architecture families. System bus 2214 also can be coupled to memory storage unit 2208 that includes both read only memory (ROM) and random-access memory (RAM). Non-volatile portions of memory storage unit 2208 or the ROM can be encoded with a boot code sequence suitable for restoring computer system 2100 to a functional state after a system reset. In addition, memory storage unit 2208 can include microcode such as a Basic Input-Output System (BIOS). In some examples, the one or more memory storage units of the various embodiments disclosed herein can include memory storage unit 2208, a USB-equipped electronic device (e.g., an external memory storage unit (not shown) coupled to input/output port 2112), hard drive 2114, and/or one or more CD-ROM, DVD, Blu-Ray, or other suitable media, such as media configured to be used in CD-ROM and/or DVD drive 2116 inside chassis 2102 or in a detachable driver coupled to input/output port 2112.

Non-volatile or non-transitory memory storage unit(s) refer to the portions of the memory storage unit(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, or (ii) the Android™ operating system developed by Google, of Mountain View, California, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 2210.

Various I/O devices such as a disk controller 2204, a graphics adapter 2224, a video controller 2202, a keyboard adapter 2226, a mouse adapter 2206, a network adapter 2220, and other I/O devices 2222 can be coupled to system bus 2214. Keyboard adapter 2226 and mouse adapter 2206 can be coupled to a keyboard 2104 and a mouse 2110, respectively, of computer system 2100. While graphics adapter 2224 and video controller 2202 are shown as distinct units, video controller 2202 can be integrated into graphics adapter 2224, or vice versa in other embodiments. Video controller 2202 is suitable for refreshing a monitor 2106 to display images on a screen 2108 of computer system 2100. Disk controller 2204 can control hard drive 2114, input/output port 2112, and CD-ROM and/or DVD drive 2116. In other embodiments, distinct units can be used to control each of these devices separately.

In some embodiments, network adapter 2220 can comprise and/or be implemented as a WNIC (wireless network interface controller) card (not shown) plugged or coupled to an expansion port (not shown) in computer system 2100. In other embodiments, the WNIC card can be a wireless network card built into computer system 2100. A wireless network adapter can be built into computer system 2100 by having wireless communication capabilities integrated into the motherboard chipset (not shown), and/or implemented via one or more dedicated wireless communication chips (not shown), connected through a PCI (peripheral component interconnector) or a PCI express bus of computer system 2100 or input/output port 2112. In other embodiments, network adapter 2220 can comprise and/or be implemented as a wired network interface controller card (not shown).

Although many other components of computer system 2100 are not shown, such components and their interconnection are well known to those of ordinary skill in the art. Accordingly, further details concerning the construction and composition of computer system 2100 and the circuit boards inside chassis 2102 are not discussed herein.

When computer system 2100 is running, program instructions stored on a USB drive in input/output port 2112, on a CD-ROM or DVD in CD-ROM and/or DVD drive 2116 or in the detachable CD-ROM and/or DVD drive coupled to input/output port 2112, on hard drive 2114, or in memory storage unit 2208 are executed by CPU 2210. A portion of the program instructions, stored on these devices, can be suitable for carrying out all or at least part of the techniques described herein. In various embodiments, computer system 2100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components can reside at various times in different storage components of computer system 2100, and can be executed by CPU 2210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 2100 is illustrated as a laptop computer, tower server, and smartphone, there can be examples where computer system 2100 can take a different form factor while still having functional elements similar to those described for computer system 2100. In some embodiments, computer system 2100 can comprise a single computer, a single server, or a cluster or collection of computers or servers, or a cloud of computers or servers. Typically, a cluster or collection of servers can be used when the demand on computer system 2100 exceeds the reasonable capability of a single server or computer. In certain embodiments, computer system 2100 may comprise a portable computer, such as a laptop computer. In certain other embodiments, computer system 2100 can comprise a mobile device, such as a smartphone, smart glasses, smart rings, wearable, virtual reality headset, augmented reality glasses, etc. In certain additional embodiments, computer system 2100 can comprise an embedded system.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automated campaign generation for display advertising has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-14 can be modified, and that the foregoing discussion of certain of these embodiments does not necessarily represent a complete description of all possible embodiments. For example, one or more of the procedures, processes, or activities of FIGS. 2-6 and 12 can include different procedures, processes, and/or activities and be performed by many different modules, in many different orders, and/or one or more of the procedures, processes, or activities of FIGS. 2-6 and 12 can include one or more of the procedures, processes, or activities of another different one of FIGS. 2-6 and 12. As another example, the elements within system 100 (FIG. 1) can be interchanged or otherwise modified.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, two seconds, five seconds, or ten seconds.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor a non-transitory computer-readable medium storing computing instructions that, when executed on the processor, cause the processor to perform operations comprising:
obtaining campaign inputs for a campaign associated with product specifications for an advertiser;
generating, using an approximate nearest neighbor similarity search, targeting cuts for a targeting tactic based at least on the campaign inputs, wherein the targeting cuts are personalized to the advertiser and the product specifications;
generating an optimized ad group plan comprising one or more groups of the targeting cuts and, for each of the one or more groups of the targeting cuts, a respective recommended maximum bid, a respective expected amount of winning impressions, and a respective budget allocation; and
outputting the optimized ad group plan for the campaign.

2. The system of claim 1, wherein the campaign inputs comprise a duration and a budget.

3. The system of claim 2, wherein the campaign inputs further comprise the targeting tactic.

4. The system of claim 1, wherein generating the targeting cuts for the targeting tactic further comprises:
performing the approximate nearest neighbor similarity search on advertiser embeddings and global embeddings.

5. The system of claim 4, wherein generating the targeting cuts for the targeting tactic further comprises:
generating the advertiser embeddings for the targeting tactic based at least on historical campaign datasets.

6. The system of claim 4, wherein generating the targeting cuts for the targeting tactic further comprises:
generating the global embeddings for the targeting tactic based at least on historical shopping behaviors.

7. The system of claim 6, wherein generating the global embeddings, for the targeting tactic of keywords or behavioral, further comprises:
generating the global embeddings using a sentence transformer model.

8. The system of claim 6, wherein generating the global embeddings, for the targeting tactic of contextual, further comprises:
generating the global embeddings using a co-purchase model and a co-view model.

9. The system of claim 1, wherein generating the optimized ad group plan further comprises:
using a mixed integer non-linear programming formulation to determine the one or more groups of the targeting cuts and optimize the respective budget allocation to each of the one or more groups.

10. The system of claim 9, wherein the mixed integer non-linear programming formulation uses a piecewise function of linear segments to approximate a non-linear win-rate function.

11. A computer-implemented method comprising:
obtaining campaign inputs for a campaign associated with product specifications for an advertiser;
generating, using an approximate nearest neighbor similarity search, targeting cuts for a targeting tactic based at least on the campaign inputs, wherein the targeting cuts are personalized to the advertiser and the product specifications;
generating, using a mixed integer non-linear programming formulation, an optimized ad group plan comprising one or more groups of the targeting cuts and, for each of the one or more groups of the targeting cuts, a respective recommended maximum bid, a respective expected amount of winning impressions, and a respective budget allocation; and
outputting the optimized ad group plan for the campaign.

12. The computer-implemented method of claim 11, wherein the campaign inputs comprise a duration and a budget.

13. The computer-implemented method of claim 11, wherein generating the targeting cuts for the targeting tactic further comprises:
generating advertiser embeddings for the targeting tactic based at least on historical campaign datasets;
generating global embeddings for the targeting tactic based at least on historical shopping behaviors; and
performing the approximate nearest neighbor similarity search on the advertiser embeddings and the global embeddings.

14. The computer-implemented method of claim 13, wherein generating the global embeddings further comprises:
for the targeting tactic of keywords or behavioral, generating the global embeddings using a sentence transformer model; and
for the targeting tactic of contextual, generating the global embeddings using a co-purchase model and a co-view model.

15. The computer-implemented method of claim 11, wherein the mixed integer non-linear programming formulation uses a piecewise function of linear segments to approximate a non-linear win-rate function.

16. A non-transitory computer-readable medium storing computing instructions that, when executed on a processor, cause the processor to perform operations comprising:
obtaining campaign inputs for a campaign associated with product specifications for an advertiser, wherein the campaign inputs comprise a duration and a budget;
generating, using an approximate nearest neighbor similarity search, targeting cuts for a targeting tactic based at least on the campaign inputs, wherein the targeting cuts are personalized to the advertiser and the product specifications;
generating an optimized ad group plan comprising one or more groups of the targeting cuts and, for each of the one or more groups of the targeting cuts, a respective recommended maximum bid, a respective expected amount of winning impressions, and a respective budget allocation; and
outputting the optimized ad group plan for the campaign.

17. The non-transitory computer-readable medium of claim 16, wherein the campaign inputs further comprise the targeting tactic.

18. The non-transitory computer-readable medium of claim 16, wherein generating the targeting cuts for the targeting tactic further comprises:
generating advertiser embeddings for the targeting tactic based at least on historical campaign datasets;
generating global embeddings for the targeting tactic based at least on historical shopping behaviors; and
performing the approximate nearest neighbor similarity search on the advertiser embeddings and the global embeddings.

19. The non-transitory computer-readable medium of claim 18, wherein generating the global embeddings further comprises:
for the targeting tactic of keywords or behavioral, generating the global embeddings using a sentence transformer model; and
for the targeting tactic of contextual, generating the global embeddings using a co-purchase model and a co-view model.

20. The non-transitory computer-readable medium of claim 16, wherein generating the optimized ad group plan further comprises:
using a mixed integer non-linear programming formulation to determine the one or more groups of the targeting cuts and optimize the respective budget allocation to each of the one or more groups,
wherein:
the mixed integer non-linear programming formulation uses a piecewise function of linear segments to approximate a non-linear win-rate function.
